(19) United States
(12) Patent Application Publication
(10) Pub. No.: US 2004/0040896 A1
(43) Pub. Date: Mar. 4, 2004

(54) Method and tool for extracting media from containers

(76) Inventors: Keith A. Koutsky, Durham, NC (US); Gregory Meyers, Mebane, NC (US)

Correspondence Address: PARADIGM GENETICS, INC, 108 ALEXANDER DRIVE, P O BOX 14528, RTP, NC, 27709-4528, US

(21) Appl. No.: 10/653,480

(22) Filed: Sep. 2, 2003

Related U.S. Application Data
(60) Provisional application No. 60/407,457, filed on Aug. 30, 2002.

(51) Int. Cl. B07B 1/49; B07B 1/28

(52) U.S. Cl. 209/417; 209/418; 209/309

(57) ABSTRACT

A media collection device for retrieving separation media from a container containing the media and organic or inorganic materials is described. The device has a media collecting sieve, support shaft, handle and vibrating source. The device can further have a retainer for the support shaft, a rotating motor, a sliding mechanism, a stage adjustable in height and/or angle, a media receptacle and a container stand adjustable in angle, height and position relative to the stage. Multiple media collection devices can be joined together to simultaneously collect media from multiple containers.

In operation, the media collection device is manipulated so that the media collecting sieve is within a container. The media collection device is manipulated so that the sieve scrapes the sides and bottom of the container, collecting material and media thereon. The media collection sieve is vibrated through vibration of at least a portion of the support shaft by a vibrating source such that the material separates from the media and passes through the sieve, while the media is retained on the sieve. The media collection device is removed completely from the container, the media put into a receptacle. The process can be repeated as required.

### FIELD OF THE INVENTION

A method of extracting media from a container without significant loss of desirable material from the container is described.

### BACKGROUND OF THE INVENTION

Various media, including separation media and pulverizing agents, are frequently used to isolate compounds or biological material. Separation media can include beads having a uniform shape such as spherical, cylindrical or banded satellite, or irregular shaped particles of an inorganic nature. Frequently, the separation media, regardless of shape, are comprised of glass, a polymer, or other inert substance, that can be coated with a chemical or organic substance for reaction and/or complexation with a desired compound or biological agent.

Pulverizing agents are used for mechanical disruption of materials such as friable solids, for example plants, soil, bulk chemicals and pills, cell membranes, nucleic acids, proteins, polymers and other inorganic or organic materials as known to practitioners in the art. Pulverizing agents are usually hard, dense material, preferably unreactive with the material to be pulverized, such as but not limited to tungsten carbide, zirconium oxide, or ceramic.

Media vary in size depending upon intended use. Media generally range in size from about 1 mm to about 15 mm, although smaller and larger sized media can be used, as known to practitioners in the art. Typically, media is from about 5 mm to about 10 mm in size, although larger and smaller sized media are acceptable dependent upon use, as known to and determinable by practitioners in the art.

Because media when used is surrounded by desired materials, often in solution or a slurry form, the media is difficult to recover without loss of the desired chemical or biological materials. Media typically is recovered through either removal of individual medium particles with an instrument, or by transfer of the media and desired materials to a sieve or filter, whereby the media is retained and the desired materials pass through the sieve or filter to a second container. These methods are laborious, time consuming and have great potential for significant loss of material through multiple transfers.

Thus, it is desirable to have an improved method for extracting media from containers which is less time consuming, less labor intensive, and wherein little or no desirable material is lost during recovery of the media.

### SUMMARY OF THE INVENTION

A device and method for extracting media from containers comprising media and materials is described wherein the method is quick, easy and efficient, resulting in a saving of time, labor and materials.

The media collection device comprises a media collecting sieve attached to a support shaft, and a vibration source capable of acting on the support shaft. The media collection device optionally can include a handle portion of the support shaft that is preferably insulated.

An automated media collection device further comprises a retainer for the support shaft and a rotating motor connecting with the support shaft. The rotating motor can be on a stage capable of height and angle adjustment. The rotating motor or stage further can be on a sliding mechanism for facilitating linear movement of the media collection device.

The method comprises connecting the media collecting sieve to the support shaft, inserting the media collecting sieve into a container, manipulating the media collecting sieve by means of the support shaft so as to collect container materials and media onto the media collecting sieve, vibrating the support shaft and media support sieve for a time sufficient to enable the material to separate from the media and drain through the sieve, removing the media collecting sieve with media from the container by means of the support shaft, and, optionally, emptying the media into a receptacle. This is repeated until all media is separated from the material.

The method can be automated in whole or in part. When automated, a rotating motor drives the support shaft to scrape the container, collecting material and media onto the media collecting sieve. The vibration source vibrates the support shaft, causing the media collecting sieve to vibrate so that materials separate from the media and pass through the sieve to the container. The media collecting sieve and support shaft can be moved linearly into and out of communication with the container by means of a sliding mechanism. The media collection device further can be angled and lowered or raised by means of a stage below the rotating motor.

### BRIEF DESCRIPTION OF THE FIGURES

The device and methods will be described herein with reference to the Figures, wherein like parts are numbered the same throughout. The Figures are as follows:

FIG. 1 depicts a media collection device;

FIG. 2 depicts a removable media collecting sieve;

FIG. 3 depicts a media collection device with a vibration source;

FIG. 4 depicts an automated media collection device; and

FIG. 5 depicts a second automated media collection device.

### DETAILED DESCRIPTION OF THE FIGURES

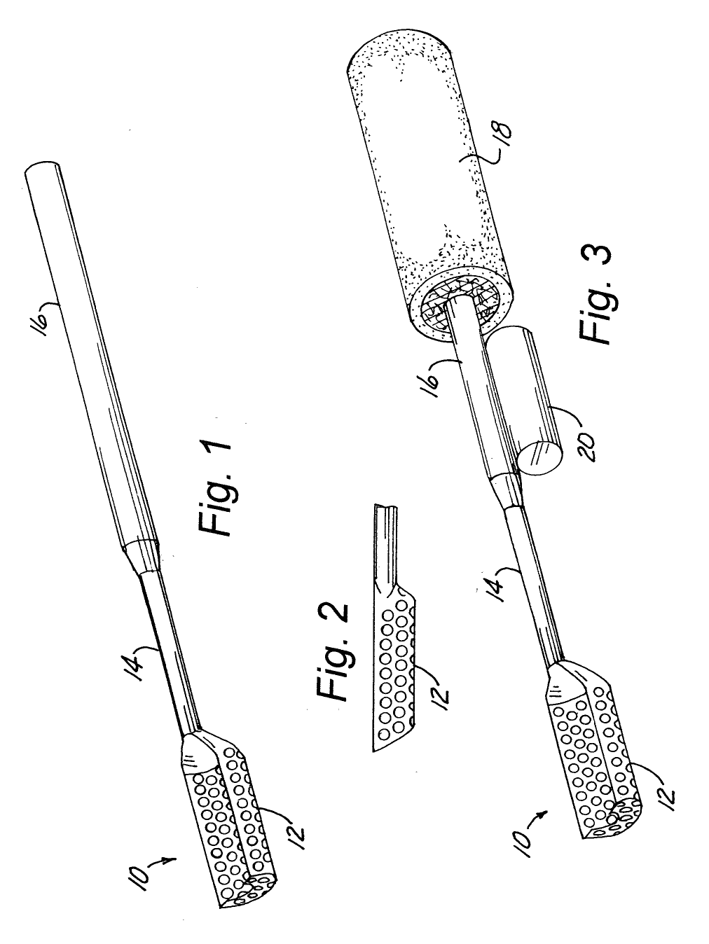

A media collection device 10 as described herein and shown in FIGS. 1-5 can be manually or automatically operated, in whole or in part, as described below. The primary media collection device 10 as shown in FIG. 1 comprises a media collecting sieve 12, a support shaft 14 and a handle 16. A vibration source 20, as shown in FIG. 3, interacts with the support shaft 14. If automated, the media collection device further comprises one or more of a retainer 22 for the support shaft 14, rotating motor 24, sliding mechanism 28, stage 26 capable of angle and height adjustment, receptacle 30 for media, and stand 34 for a container 32, as shown in FIG. 5. The media collection device 10 and its operation are now described in detail with reference to the figures.

Manual Media Collection Device

A. Media Collecting Sieve

As shown in FIG. 2, the media collecting sieve 12 comprises a sieve material, desirably formed so as to have a depression therein creating a scoop. The size and shape of the sieve and the depth of the depression can vary based on the size media and size and shape container with which the media collecting sieve will be used. The sieve will be of a composition and stiffness so as to retain the desirable sized media thereon, while allowing other materials to pass through the sieve to the container. The collecting sieve can be made from any suitable material, including but not limited to a plastic, such as polypropylene, a stainless metal and/or a teflon coated metal, ceramic or glass. It is preferred that the sieve material be non-reactive with the biological and/or chemical agents with which it will come into contact.

The media collecting sieve 12 is porous, having openings of any suitable size and shape for the material and media being sieved. The sieve preferably is constructed so as to retain all media, while allowing the most possible biological and/or chemical material to pass through. Preferably, at least about 90% of the biological and/or chemical material will pass through the sieve, more preferably at least about 95% or more, and most preferably about 99% or more. The sieve can be formed in any manner appropriate to the sieve material, such as molding, casting, shaping or the like. The sieve can be formed of a web of material, or from a solid material formed with perforations or perforated after formation. A web of glass, wires or other suitable materials can be formed into an appropriate shape to act as a sieve. Similarly, the sieve can comprise bands of material connected at one or more points to form slats through which the biological and/or chemical material can pass. The shape of the sieve can include a perforated spoon, perforated shovel, rake, or other suitable formation as will be apparent to practitioners in the art.

The media collecting sieve 12 can be integral with, or detachable from, a first end of a support shaft 14. Preferably, the media collecting sieve 12 is detachable for easy cleaning or disposal and replacement. In many cases, it will be preferable to dispose of the media collecting sieve after use, and replace it with a new media collecting sieve rather than washing the media collecting sieve. If the sieve is to be disposable, it is preferably made of a less expensive material, such as a plastic, for example, polypropylene. If the collecting sieve is to be cleaned, a batch cleaning method is preferred for maximum efficiency.

The media collecting sieve 12 can be attached to a first end of the support shaft 14 by any suitable means known in the art, including screwing into place, snap fit, compression or the like. The support shaft 14 can be made of any suitable material, such as but not limited to, glass, stainless steel, polypropylene, aluminum or any other preferably non-reactive material as known to practitioners in the art. Preferably, the material should be easy to clean, and more preferably non-porous. The support shaft 14 can be made by any suitable process, including injection molding, casting, forming or the like. If mass produced, the shafts preferably are injection molded.

B. Vibration Source

As shown in FIG. 3, a vibration source 20 is attached to the support shaft 14 above the media collecting sieve 12, and is capable of being turned on and off. A power source for the vibration source 20 can be a battery integral therewith or a remote electrical supply. The vibration source 20 can comprise a motor and an eccentric weight, solenoid, voice coil, piezoelectric device, or other vibration source as known to practitioners in the art. The vibration source is preferably small in size and light in weight such that the device can easily be handheld. Alternatively, the vibration can be supplied by human movement. When operated, the vibration source 20 causes the support shaft 14 or a portion thereof and the media collecting sieve 12 to vibrate. The vibration source 20 can be of variable speed and power, or constant at a desirable level. The vibration source 20 can also be positioned concentrically around the support shaft 14, or in any other suitable configuration.

The speed and power of the vibrating motion required to separate the media from the material will be determined by the size of the media, the nature of the material and the configuration of the media collecting sieve. The speed and power of the vibration should be sufficient to separate the material from the media through the media collecting sieve, while not quite strong enough to cause material or media to fall off the top of the media collecting sieve.

C. Support Shaft and Handle

As shown in FIG. 3, a second end of the support shaft 14 comprises a handle 16, preferably insulated with insulating material 18 as known to practitioners in the art to dampen the vibration from the vibration source 20. Rubber, urethane, or other suitable materials or combinations thereof as known in the art can be used as insulators 18 for the handle 16 of the support shaft 14.

D. Container Stand

As shown in FIG. 5, the automated media collection device further can comprise, or interact with, a stand 34 for holding the container 32 having the media and material. The stand 34 and stage 26 or sliding mechanism 28 can be connected by means of a platform, or can be separate. The stand 34 firmly holds the container 32 in a clamp or receptacle to prevent movement of the container 32. The stand can be of any suitable configuration known to practitioners in the art based on the container size and shape. The stand 34 is either set or adjustable to a suitable angle for interaction with the automated media collection device. The stand 34 can be linearly movable toward and away from the media collection device and/or adjustable in height and angle to allow easy placement and removal of containers 32 and interaction with the automated media collection device. The container 32 can be moved instead of the media collecting sieve and support shaft for interaction therewith, or both the container and the media collecting sieve via the support shaft can be moved into coordinating positions as desired.

E. Manual Method of Collecting Media

For manual use, a person will hold the media collection device 10 by the handle 16, preferably insulated with insulating material 18, and insert the media collecting sieve 12 as attached to the support shaft 14 into a container 32 including media and material therein. The media collection device 10 is maneuvered within the container 32 to scoop a combination of material and media into the media collecting sieve 12, scraping the sides and bottom of the container 32. The media collection device 10 is vibrated, causing the material to separate from the media. The material will pass through the sieve back into the container, while the media will be retained on the media collecting sieve 12. The vibration can be supplied either by manipulation of the person's hand, or by activation of a vibration source attached to the support shaft 14. If a vibration source is used, the vibration can be continuously supplied throughout the media collection process if desired, thus eliminating the necessity of turning the vibration power supply on and off repeatedly. Once the material is separated from the media on the media collecting sieve 12, the media collection device 10 is completely removed from the container and the media is deposited in a suitable receptacle to await further processing. The process can be repeated as many times as necessary to remove all media from the material. Depending on the fullness of the container, the sieve may need to be partially removed from the container to effectively separate the media from the biological and/or chemical material. The speed of the sieve vibration and speed of retraction from cooperation with the container can be determined for each container volume and media/material combination and adjusted in order to attain maximum media removal with minimum loss of material. After collection, the media can be further processed as known to one of ordinary skill in the art, such as by washing, removing attached material, reusing or disposal of the media.

F. Control of Motorized Parts

Any individual moving part of the above-described system can be motorized or automated. Parts capable of automation include the vibration source 20, rotating motor 24, sliding mechanism 28, angle adjustment of the stage 26, height adjustment of the stage 26, angle of the container stand 34, linear movement of the container stand 34, and height of the container stand 34, each of which can independently be motorized or automated. Each automated part can be separately operated, or interconnected through a control panel. The control panel can allow separate operation of each part of the media collection device, or can be computerized to follow a set sequence of steps. The steps and parameters for operating the media collection device can be determined based on conditions such as volume, type, and weight of material in the container, and the quantity or weight of media to be collected.

G. Determination of Endpoint

It can be beneficial to add a means of monitoring the removal of media from the container in order to determine if all media has been removed from the container. Whether done manually, or with the aid of automated parts, the process of separating media from materials will be repeated until all media is removed from the container. The end point of a manual and/or automated collection of media from a container can be determined by several different means. If a known quantity or mass of media is in each container, the removed media can be counted or weighed as it is removed from the container and/or deposited into the receptacle. Alternately, the container can be continuously weighed for a difference in weight equal to the weight of the media. Other endpoint measurement means include, but are not limited to, visual detection such as photo beam detection, audio detection such as shaking the container to observe a presence or lack of rattling sounds, and other means as known to practitioners in the art. These detection means can be manual or automated by any means known to practitioners in the art.

Automated Media Collection Device

A. Rotating Motor

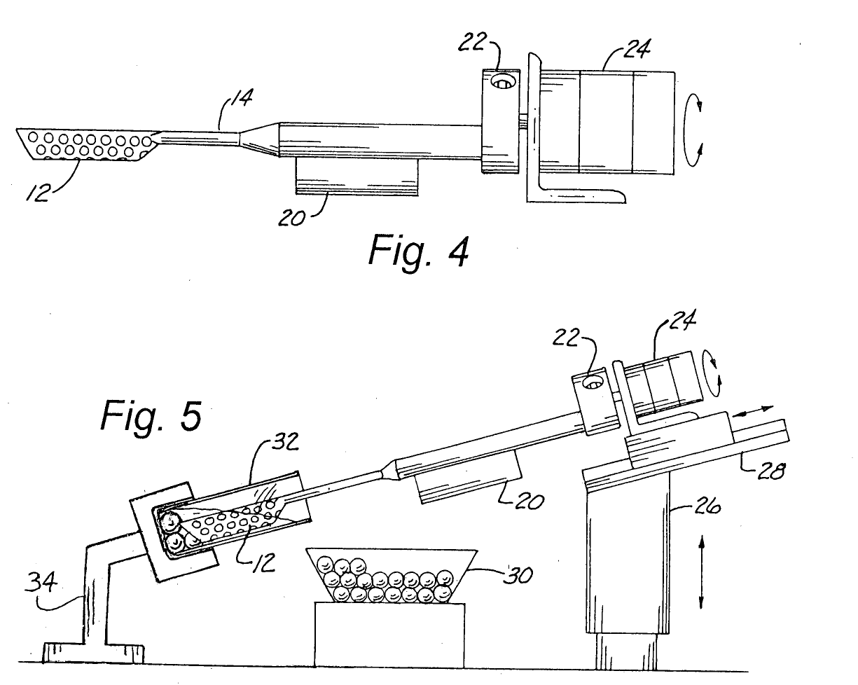

The media collection method can be automated in any suitable manner. For example, as shown in FIG. 4, a second end of the support shaft 14 is held in a retainer 22 and connects with a rotating motor 24. The rotating motor 24 is connected to the support shaft 14 so as to cause off-axis rotation of the support shaft 14 such that the media collecting sieve 12 moves in a scooping motion. The rotating motor 24 can be connected directly to a power source, or through a control panel. The rotating motor 24 is operated to scoop media with material into the media collecting sieve 12, and to deposit separated media into a suitable receptacle. Other means of manipulating the support shaft and media collecting sieve as known to practitioners in the art can also be used, such as but not limited to the use of rotary stages to position the motor and support shaft relative to the container.

B. Sliding Mechanism

As shown in FIG. 5, the automated means of media collecting can further comprise a sliding mechanism 28 by which the media collection device 10 can be moved linearly into and out of a container 32. The sliding mechanism 28 can be hand operated or motorized, as desired. If motorized, the sliding mechanism 28 can be connected directly to a power source, or through a control panel. The sliding mechanism 28 can be connected to the rotating motor 24, the stage 26, or both. Alternately, the container 32 can be moved into and out of coordinating position with respect to the media collection device, such as by use of a sliding mechanism 28.

C. Stage

When automated, the media collection device 10 connected to the rotating motor 24 is preferably set on a stage 26 for elevating the media collection device 10 above a working surface and providing a desirable angle for interaction with a container 32. The stage 26 can have means of adjusting the angle of the media collection device 10 set thereon, and/or means of elevating and lowering the media collection device 10 as desired. The means of adjusting the angle and of adjusting the height of the stage 26 can be manually operated or motorized, and can comprise any method known to practitioners in the art. If motorized, the stage 26 can be connected directly to a power source or through a control panel for control of the angle and elevation. The stage 26 can be directly connected to the rotating motor 24, connected to a sliding mechanism 28 if one is desired and as shown in FIG. 5, or situated between the rotating motor 24 and the sliding mechanism 28.

D. Receptacle

The automated media collection device can include an integral or, more preferably, removable receptacle 30 into which the media collecting sieve 12 can drop collected media, as shown in FIG. 5. The receptacle 30 is placed below the media collecting device 10, and is situated so that the media collecting sieve 12 when rotated or canted deposits the media into the receptacle 30. The receptacle can be made to weigh the media deposited thereon, thus determining an end point for the collection process. The receptacle also can coordinate with further downstream processes in order to sort media by size and/or clean the media for further use, if desired. For example, the receptacle can be a funnel or other suitable device directing the flow of media to a sorting mechanism. Alternately, the receptacle itself can be a sorting mechanism for sorting media by size or weight. The receptacle also could be filled with a cleaning and/or disinfectant solution in order to clean and/or disinfect the media. Other means of utilizing the receptacle to further clean, disinfect or separate the media will be apparent to practitioners in the art.

E. Container Stand

As shown in FIG. 5, the automated media collection device further can comprise, or interact with, a stand 34 for holding the container 32 having the media and material. The stand 34 and stage 26 or sliding mechanism 28 can be connected by means of a platform, or can be separate. The stand 34 firmly holds the container 32 in a clamp or receptacle to prevent movement of the container 32. The stand can be of any suitable configuration known to practitioners in the art based on the container size and shape. The stand 34 is either set or adjustable to a suitable angle for interaction with the automated media collection device. The stand 34 can be linearly movable toward and away from the media collection device and/or adjustable in height and angle to allow easy placement and removal of containers 32 and interaction with the automated media collection device. The container 32 can be moved instead of the media collecting sieve and support shaft for interaction therewith, or both the container and the media collecting sieve via the support shaft can be moved into coordinating positions as desired.

F. Control of Motorized Parts

The motorized portions of the automated media collection device, which can include one or more of the vibration source 20, rotating motor 24, sliding mechanism 28, angle adjustment of the stage 26, height adjustment of the stage 26, angle of the container stand 34, linear movement of the container stand 34, and height of the container stand 34, can each be separately operated through a control panel, or interconnected through a central control panel or computer. Each control panel can allow separate operation of each part of the media collection device, or can be computerized to control all parts of the media collection device following a set sequence of steps. The steps and parameters for operating the media collection device can be determined based on conditions such as volume, type, and weight of material in the container, and the quantity or weight of media to be collected. If the media collection device is computerized using a central control panel or computer, it can be beneficial to add a means of monitoring the removal of media from the container in order to determine if all media has been removed from the container. The process of separating media from materials will be repeated until all media is removed from the container.

Multiple automated media collection devices can be controlled by one or more computers and/or control stations. If operating on the same media and material, one computer or control station can control a group of media collection devices. If the media collection devices are located separately in a facility, or each is working with a different media and/or material, separate means of controlling each media collection device are desirable. Various configurations and control means for media collection devices and multiple arrays of media collection devices will be apparent to practitioners in the art.

G. Automated Method of Collecting Media

When activated, the automated media collection device will linearly insert the media collecting sieve 12 attached to the support shaft 14 into the container 32. The rotating motor 24 will be activated for one cycle to enable the media collecting sieve 12 to move in a scooping manner to collect material and media from the container 32. The scooping motion enables the media collecting sieve 12 to scrape the sides and bottom of the container 32. At least a portion of the support shaft 14 is vibrated by vibration source 20, causing vibration of the media collection sieve 12 such that material thereon separates from the media and passes through the media collecting sieve 12, while the media remains on the media collecting sieve 12. After a sufficient time to ensure all material is separated from the media, the media collection device 10 is completely linearly removed from the container 32. The rotating motor 24, possibly in combination with the angle of the stage 26, is desirably activated to deposit the media in a receptacle 30. The process is then repeated until all media is removed from the container. Depending on the fullness of the container, the sieve may need to be partially removed from the container to effectively separate the media from the biological and/or chemical material. The speed of the sieve vibration and speed of retraction from cooperation with the container can be determined for each container volume and media/material combination and adjusted in order to attain maximum media removal with minimum loss of material. After collection, the media can be further processed as known to one of ordinary skill in the art, such as by washing, removing attached material, reusing or disposal of the media.

H. Automated Multiple Media Collection Device

Two or more of the automated media collection devices described above can be joined together for simultaneous automated media collection from multiple sources. The automated media collection devices can be ganged to form a multiple media collection device. Each media collection device therein can operate in unison or separately from another media collection device. The automated multiple media collection device can be controlled through a single control panel or computer, or multiple control panel or computer stations. Preferably, one control panel or computer is associated with each automated multiple media collection device. The individual media collection devices can be joined by physical means such as a platform, electronically, or by other suitable means as known to practitioners in the art to form the desired multiple media collection device configuration. The multiple media collection device can be configured to collect media from a single row of containers at one time, or from a more complex grid or circular arrangement of containers. The configuration can be designed to match that of current high speed and/or high throughput devices, such as multiple sample cell trays, multi-column assays, and the like.

Groups of automated multiple media collection devices can be controlled by one or more computers and/or control stations. If operating on the same material and media, one computer can control a group of multiple media collection devices. If the multiple media collection devices are located separately in a facility, or each is working with a different material and/or media, separate means of controlling each multiple media collection device are desirable. Various configurations and control means for media collection devices and multiple media collection devices will be apparent to practitioners in the art.

I. Determination of Endpoint

The end point of collection of media from a container can be determined by several different means. If a known quantity or mass of media is deposited in a container, the removed media can be counted or weighed as it deposited into the receptacle. Alternately, the container can be continuously weighed for a difference in weight equal to the weight of the media. Other endpoint measurement means include but are not limited to visual detection such as photo beam detection, audio detection such as shaking the container to observe a presence or lack of rattling sounds, and other means as known to practitioners in the art. These detection means can be manual or automated by any suitable means.

Exemplary Uses

The manual media collection device, automated media collection device, or multiple media collection device as described herein can be used for media collection from many different sources. Such sources include, but are not limited to, one or more of a test tube array, a multiple sample cell tray, a multi-column assay, a high speed and/or high throughput assay, a shaker table, a grinding table as described, for example, in co-pending U.S. application Ser. No. 09/870,191, and other multi-container set-ups as known to practitioners in the art. Multiple arrangements of singular test tubes, sample cells, assays and the like can also be used in with the media collection devices described herein.

Alternative materials, devices or methods of operating the media collection device manually or automatically will be apparent to practitioners in the art. All alternate devices, materials and methods within the spirit and scope of the invention are intended to be included herein. The scope of the invention is set forth in the appended claims.

We claim:

1. A media collection device comprising a media collecting sieve connected to a first end of a support shaft, and a vibration source acting on the support shaft.

2. The device of claim 1, wherein a second end of the support shaft comprises a handle.

3. The device of claim 2, wherein the handle is insulated.

4. The device of claim 1, wherein the media collecting sieve is detachable from the first end of the support shaft.

5. The device of claim 1, further comprising a rotating motor connected to a second end of the support shaft.

6. The device of claim 5, further comprising one or more rotary stage in coordination with the rotating motor.

7. The device of claim 5, further comprising a retainer holding the support shaft between the vibration source and the rotating motor.

8. The device of claim 5, further comprising a sliding mechanism attached to the rotating motor.

9. The device of claim 5, further comprising a stage adjustable in angle and height.

10. The device of claim 9, further comprising a sliding mechanism between and attached to the rotating motor and stage.

11. The device of claim 9, further comprising a sliding mechanism attached to a bottom of the stage.

12. The device of claim 1, wherein the media for collection is pulverizing beads.

13. A method for collecting media from a container comprising:
a) inserting a media collecting sieve of a media collection device into a container comprising media and materials, wherein the media collection device comprises the media collecting sieve connected to a first end of a support shaft and a vibration source acting on the support shaft;
b) lifting media and material from the container onto the media collecting sieve by manipulation of the support shaft;
c) vibrating the support shaft and media collecting sieve with the vibration source for a time sufficient for the material to drain through the media collecting sieve; and
d) withdrawing the media collecting sieve with media from the container by the support shaft.

14. The device of claim 13, further comprising depositing the media on the media collecting sieve into a receptacle.

15. The device of claim 14, further comprising weighing the deposited media in the receptacle.

16. The method of claim 13, further comprising monitoring the withdrawal of the media.

17. The method of claim 16, further comprising monitoring the withdrawal of the media by counting, weighing, electromagnetic detection, or audio detection.

18. The method of claim 13, wherein the manipulation of the support shaft is performed by a rotating motor connected to the support shaft.

19. The method of claim 18, further comprising coordinating the rotating motor with one or more rotary stage attached to the rotating motor.

20. The method of claim 19, wherein the rotary stage is adjustable in height and angle.

21. The method of claim 19, wherein the inserting and the withdrawing of the media collecting sieve into and from the container is performed using a sliding mechanism that is in communication with the rotating motor or the stage.

22. The method of claim 13, wherein the media is pulverizing beads.

23. The method of claim 13, wherein the container is part of a multiple sample cell tray.
